(19) United States
(12) Patent Application Publication
(10) Pub. No.: US 2013/0113668 A1
(43) Pub. Date: May 9, 2013

(54) Systems for Focusing and Defocusing an Antenna

(71) Applicant: Chryssoula A. KYRIAZIDOU, Kifisia (GR)

(72) Inventor: Chryssoula A. KYRIAZIDOU, Kifisia (GR)

(21) Appl. No.: 13/361,566

(22) Filed: Jan. 30, 2012

Related U.S. Application Data
(60) Provisional application No. 61/556,094, filed on Nov. 4, 2011.

(30) Foreign Application Priority Data
Dec. 28, 2011 (GR) 20110100741

(51) Int. Cl. H01Q 19/06

(52) U.S. Cl. 343/753

(57) ABSTRACT

Embodiments provide systems for focusing and defocusing an antenna. The antenna may be a printed antenna, such as a patch antenna, for example, and may include a single element antenna or a multi-element antenna array. Embodiments include a focusing/defocusing structure, including a plurality of metal rings that form a multi-layer structure, peripheral to the antenna. In an embodiment, the focusing structure is designed to have a horn configuration, with the metal rings having progressively increasing respective widths in the direction away from the antenna. As a result, the forward gain of the antenna element is enhanced. The focusing/defocusing structure may be integrated within the chip on which antenna is mounted. In other embodiments, the focusing structure is built into the chip package, or built as a micro-electro-mechanical system (MEMS)-like structure on Silicon.

### CROSS-REFERENCE TO RELATED APPLICATION(S)

This patent application claims the benefit of U.S. Provisional Patent Application No. 61/556,094, filed Nov. 4, 2011, entitled “Long Term Evolution Radio Frequency integrated Circuit,” which is incorporated herein by reference in its entirety.

### BACKGROUND

1. Field of the Invention

The field of the invention relates generally to focusing and defocusing antennas.

2. Background Art

Antenna elements and/or arrays are commonly integrated into integrated circuit (IC) packages, printed circuit boards (PCBs) that support ICs, or on-chip. In general, it may be desirable to increase or decrease the integrated antenna gain by forming more directive or more omni-directional beam shapes. Depending on the application, package, PCB, or on-chip integration, integrated antennas may feature variable aspect ratios, which may affect the radiation pattern of the antennas. For example, long and narrow form factors typically result in reduced forward gain. In addition, antennas may have frequency dependent gain, which may be desired to become uniform throughout the antenna bandwidth.

Commonly, off-chip rectangular waveguides, horn antennas, and/or reflector antennas are used to focus or defocus microwave transmissions. It is desirable, however, that on-package, on-chip structures be used to focus/defocus antennas, especially for on-chip antennas.

### BRIEF DESCRIPTION OF THE DRAWINGS/FIGURES

The accompanying drawings, which are incorporated herein and form a part of the specification, illustrate the embodiments of the disclosure and, together with the description, further serve to explain the principles of the disclosure and to enable a person skilled in the pertinent art to make and use the subject of the present disclosure.

FIG. 1 is a three-dimensional view of an example system for focusing an antenna.

FIG. 2 is a side view of an example system for focusing an antenna.

FIG. 3 is a top view of an example system for focusing an antenna.

FIG. 4 is a top view of an example system for focusing an antenna.

FIG. 5 is a top view of an example metal element.

FIG. 6 is a side view of an example system for de-focusing an antenna.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

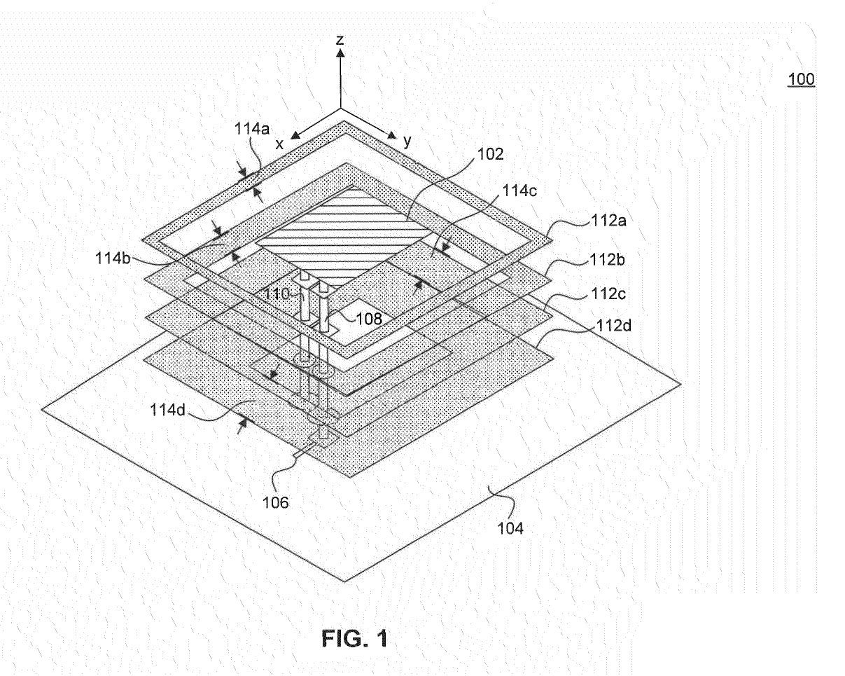

FIG. 1 is a three-dimensional view of an example system 100. Example system 100 includes an antenna element 102 and a structure for focusing antenna element 102 (radiation shaping structure). Example system 100 is provided for the purpose of illustration only and is not limiting of embodiments of the present disclosure.

Antenna element 102 may be a printed or a microstrip antenna, such as a patch antenna, for example. In example system 100, antenna element 102 has a square shape. In other embodiments, antenna element 102 may be rectangular, elliptical, circular, or of any other continuous shape (e.g., a continuous shape that may be accompanied by parasitic discontinuous elements, such as, a central patch element that is directly fed with secondary patches around the main patch, for example). Antenna element 102 may be an on-chip or an off-chip antenna. When antenna element 102 is an on-chip antenna, antenna element 102 may be formed by etching an antenna pattern onto a dielectric substrate, for example.

As shown in FIG. 1, antenna element 102 is mounted above a ground plane 104. In an embodiment, antenna element 102 is mounted above ground plane 104 using one or more dielectric spacer layers in between (not shown in FIG. 1). A feed line (to a transmitter or a receiver) is provided to antenna element 102 using a through-chip via 108, which couples antenna element 102 to a feed line probe 106. Antenna element 102 may also be fed by proximity, that is, through-chip 108 via may pass through one or more dielectric spacer layers without making contact with antenna element 102 itself. A ground line may be provided to antenna element 102 via a through-chip via 110, which may couple antenna element 102 to ground plane 104. In other embodiments, example antenna system 100 does not include a ground plane 104. Through-chip via 110 is thus eliminated.

The focusing structure includes a plurality of metal rings 112a-d, each set in a respective plane parallel to ground plane 104, that form a multi-layer structure, peripheral to antenna element 102. In an embodiment, the focusing structure is integrated within the chip on which antenna element 102 is mounted. Various dielectric layers may be used between any two metal rings 112. In other embodiments, the focusing structure is built on-chip, into the chip package, into the chip PCB (i.e., the PCB that supports the IC chip), or built as a micro-electro-mechanical system (MEMS)-like structure on Silicon. Metal rings 112a-d may or may not be connected to each other using one or more vias, for example. For example, one or more pair of consecutive rings of metal rings 112a-d may be connected to each other. In addition, one or more of metal rings 112a-d may be connected to ground plane 104. For example, the bottom most ring 112d may be connected to ground plane 104.

In an embodiment, as shown in FIG. 1, the focusing structure is designed to have a horn configuration, with metal rings 112a-d having progressively increasing respective widths 114a-d in the direction away from antenna element 102 towards ground plane 104. In the horn configuration, metal ring 112a which is closest to antenna element 102 has the narrowest width 114a, and metal ring 112d which is farthest from antenna element 102 has the widest width 114d. Accordingly, the focusing structure forms a virtual curved reflector and shapes the radiation pattern of antenna element 102 in the same way as a curved reflector. As a result, the forward gain of antenna element 102 is enhanced. For example, 1 dB of forward gain enhancement can be realized with a two-layer reflector. In another embodiment, one or more of metal rings 112a-d may have the same width 114. For example, one or more pair of consecutive rings of metal rings 112a-d may have the same width 114.

Each of widths 114a-d may or may not be uniform along the sides. For example, referring to metal ring 112a, the metal ring may have different side widths along the x-direction and the y-direction. Different side widths may be used to transform the antenna radiation into a “fan-shape,” which is more compressed along one of the two directions (x-direction or y-direction). In addition, the different sides of a ring may or may not have the same distance to antenna element 102.

Generally, the performance of the focusing structure is determined, primarily, by widths 114a-d of metal rings 112a-d. Specifically, the respective values of widths 114a-d determine the amount of focusing provided by the focusing structure. Other factors may also affect the performance of the focusing structure, including, for example, the distance among rings 112a-d along the z-direction (see FIG. 1), the geometrical shape of rings 112a-d (rectangular, circular, elliptical, etc.), the electrical properties of dielectric layers that separate rings 112a-d, and the presence or absence of vias connecting consecutive rings or connecting rings to ground plane 104 (e.g., connecting the bottom ring 112d to ground plane 104).

According to embodiments, metal rings 112a-d may have any geometrical shape, including a square shape, as shown in FIG. 1. As such, embodiments can accommodate various form factor requirements.

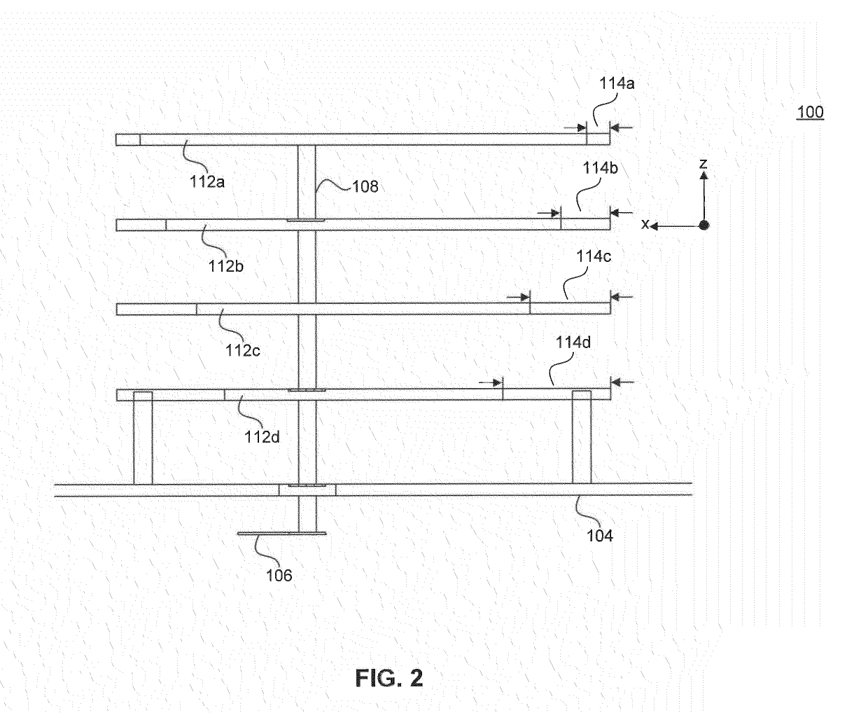

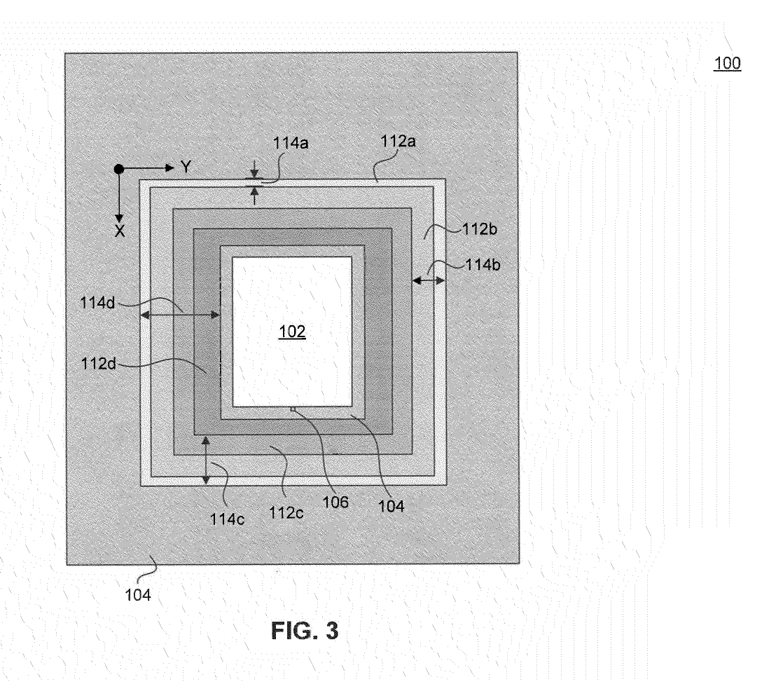

FIG. 2 is a side view of example system 100 described above in FIG. 1. FIG. 3 is a top view of example system 100 described above in FIG. 1. Like FIG. 1, FIGS. 2 and 3 illustrate the horn configuration of the focusing structure, with metal rings 112a-d having progressively increasing respective widths 114a-d in the direction away from antenna element 102 (not shown in FIG. 2) towards ground plane 104. In addition, FIG. 2 shows that metal ring 112d is, in fact, coupled to ground plane 104.

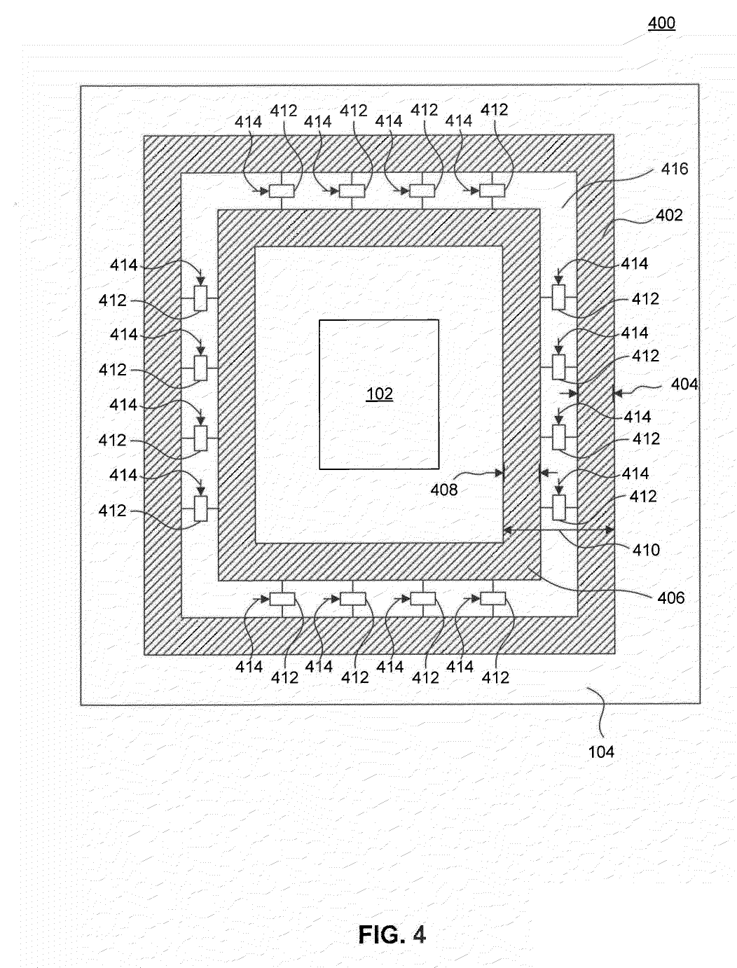

FIG. 4 is a top view of an example system 400 for focusing an antenna. Like example system 100, example system 400 includes an antenna element 102 and a structure for focusing antenna element 102. Example system 400 is provided for the purpose of illustration only and is not limiting of embodiments of the present disclosure.

As described above with reference to FIG. 1, antenna element 102 is mounted above a ground plane 104. In an embodiment, antenna element 102 is mounted above ground plane 104 using one or more dielectric spacer layers in between (not shown in FIG. 4). In other embodiments, example antenna system 400 does not include a ground plane 104.

The focusing structure includes a plurality of metal elements that form a multi-layer structure, peripheral to antenna element 102. In an embodiment, the focusing structure is integrated within the chip on which antenna element 102 is mounted. Various dielectric layers may be used between any two metal elements of the focusing structure. In other embodiments, the focusing structure is built on-chip, into the chip package, into the chip PCB (i.e., the PCB that supports the IC chip), or built as a micro-electro-mechanical system (MEMS)-like structure on Silicon. The metal rings may or may not be connected to each other using one or more vias, for example. For example, consecutive rings may be connected to each other. In addition, one or more of the metal rings may be connected to ground plane 104. For example, the bottom most ring may be connected to ground plane 104.

For the purpose of simplification, a single metal element of the plurality of metal elements of the focusing structure is shown in FIG. 4. As shown in FIG. 4, the metal element includes two concentric metal rings 402 and 406. Rings 402 and 406 have respective widths 404 and 408, which may be equal or different. A gap area 416 separates rings 402 and 406 to create a discontinuous metallization. Metal rings 402 and 406 may be electrically coupled to each other via a plurality of active switches 412, each controlled by a respective control signal 414. When coupled to each other, metal rings 402 and 406 form a single continuous metal ring with an effective width 410. Otherwise, the metal element provides two separate metal rings of widths 404 and 408.

The focusing structure of example system 400 may be designed to have a horn configuration as described above, with the metal elements of the focusing structure having progressively increasing respective effective widths in the direction away from antenna element 102 towards ground plane 104. In the horn configuration, the metal element which is closest to antenna element 102 has the narrowest effective width, and the metal element which is farthest from antenna element 102 has the widest effective width. Accordingly, the focusing structure forms a virtual curved reflector and shapes the radiation pattern of antenna element 102 in the same way as a curved reflector. As a result, the forward gain of antenna element 102 is enhanced.

According to embodiments, the metal elements may have any geometrical shape, including a square shape, as shown in FIG. 4. As such, embodiments can accommodate various form factor requirements, so long that the effective widths of the metal elements are selected appropriately for the desired focusing performance.

According to embodiments, each of the metal elements of the focusing structure may have any number of concentric metal rings, each of which may be electrically coupled to an adjacent ring independently of the others. Further, each of the metal elements of the focusing structure can be controlled, independently of other metal elements, to adjust its respective effective width.

As such, the focusing performance of the focusing structure may be dynamically adjusted as desired. For example, using active switches 412, the focusing structure may be adjusted dynamically from an omni-directional configuration to a forward gain enhancing configuration (e.g., horn configuration), or vice versa. Further, the focusing performance of the focusing structure may be adjusted dynamically according to the frequency of the transmitted or received signal. For example, the forward gain of the focusing structure may be increased/decreased at selected frequencies by varying dynamically the focusing structure configuration. The focusing structure of example system 400 may also be disabled when no focusing is desired. For example, this can be done by configuring each of the metal elements of the focusing to have the same effective width.

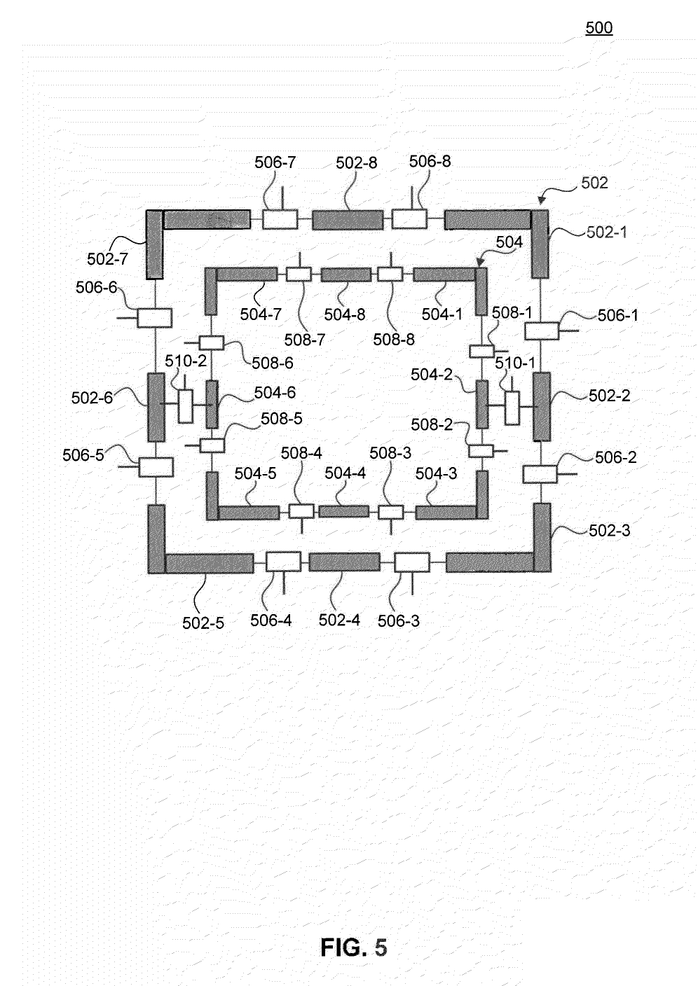

FIG. 5 is a top view of an example metal element 500. Metal element 500 may be used, along with other similar elements, in a focusing or defocusing structure.

As shown in FIG. 5, example metal element 500 includes two concentric metal rings 502 and 504. Metal ring 502 includes a plurality of side elements 502-1 to 502-8 and a plurality of active switches 506-1 to 506-8. Active switches 506-1 to 506-8 are placed in between side elements 502-1 to 502-8, such that the metal connectivity of metal ring 502 is interrupted. Similarly, metal ring 504 includes a plurality of side elements 504-1 to 504-8 and a plurality of active switches 508-1 to 508-8. Active switches 508-1 to 508-8 are placed in between side elements 504-1 to 504-8, such that the metal connectivity of metal ring 504 is interrupted. As would be understood by a person of Skill in the art based on the teachings herein, metal rings 502 and 504 may include more or less side elements or active switches than shown in FIG. 5. In addition, example metal element 500 includes a plurality of active switches 510-1 and 510-2, located in a gap area between metal rings 502 and 504. Example metal element 500 may include more or less active switches 510 than shown in FIG. 5.

Each of active switches 506, 508, and 510 is controlled by a respective control signal, which allows the individual switch to be opened or closed, independently of the other switches in the system. As such, example metal element 500 can be configured into various configurations by selecting an open or closed state for each of the active switches, resulting in various antenna radiation patterns.

In an embodiment, all of active switches 506 (and/or 508) are open, which results in a metal ring 502 (and/or 504) with a disconnected metallization. Such disconnected metallization does not have an impact on the antenna radiation pattern. In another embodiment, some or all of active switches 506 (and/or 508) are closed, resulting in partial or full connectivity of metal ring 502 (and/or 504). Partial or full connectivity of metal ring 502 and/or 504 may have an impact on the antenna radiation pattern.

In addition, as in example system 400, metal rings 502 and 504 may be connected to each other using active switches 510, to form a single continuous metal ring having a larger effective width. For example, in an embodiment, all of active switches 506 and 508 are closed resulting in full connectivity of metal rings 502 and 504, which are farther connected to each other by closing active switches 510. In another example, some of active switches 506 are closed resulting in a partially connected metal ring 502. (e.g., switches 506-1 and 506-2 are closed resulting in a connected section comprising 5024, 502-2, and 502-3). The connected section of metal ring 502 is connected, via one or more of active switches 510, to a fully connected metal ring 504 (where all active switches 508 are closed) or to a connected section of metal ring 504 (where some but not all of active switches 508 are closed).

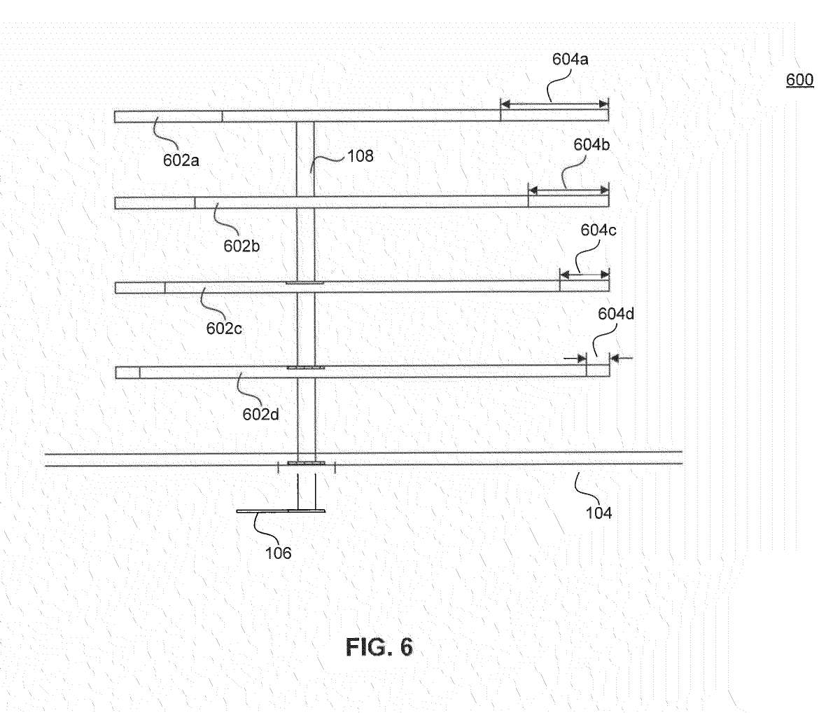

FIG. 6 is a side view of an example system 600. Example system 600 includes an antenna element 102 (not shown in FIG. 6) and a structure for defocusing antenna element 102 (radiation shaping structure). Example system 600 is provided for the purpose of illustration only and is not limiting of embodiments of the present disclosure.

Antenna element 102 may be a printed or a microstrip antenna, such as a patch antenna, for example. Antenna element 102 may be of a square, rectangular, elliptical, circular, or any other continuous shape. Antenna element 102 may be an on-chip or an off-chip antenna.

Antenna element 102 is mounted above a ground plane 104 in the same way as shown in FIG. 1. In an embodiment, antenna element 102 is mounted above ground plane 104 using one or more dielectric spacer layers in between (not shown in FIG. 6). A feed line (to a transmitter or a receiver) is provided to antenna element 102 using a through-chip via 108, which couples antenna element 102 to a feed line probe 106. A ground line is provided to antenna element 102 via a through-chip via (not shown in FIG. 6), which couples antenna element 102 to ground plane 104. In other embodiments, example antenna system 600 does not include a ground plane 104.

The defocusing structure includes a plurality of metal rings 602a-d that form a multi-layer structure, peripheral to antenna element 102. In an embodiment, the defocusing structure is integrated within the chip on which antenna element 102 is mounted. Various dielectric layers may be used between any two metal rings 602. In other embodiments, the defocusing structure is built on-chip, into the chip package, into the chip PCB (i.e., the PCB that supports the IC chip), or built as a micro-electro-mechanical system (MEMS)-like structure on Silicon. Metal rings 602a-d may or may not be connected to each other using one or more vias, for example. For example, consecutive rings of metal rings 602a-d may be connected to each other. In addition, one or more of metal rings 602a-d may be connected to ground plane 104. For example, the bottom most ring 602d may be connected to ground plane 104.

In an embodiment, as shown in FIG. 6, the defocusing structure is designed to have an inverted horn configuration, with metal rings 602a-d having progressively decreasing respective widths 604a-d in the direction away from antenna element 102 towards ground plane 104. In the inverted horn configuration, metal ring 602a which is closest to antenna element 102 (e.g., on the same vertical level as antenna element 102) has the widestwidth604a, and metal ring 602d which is farthest from antenna element 102 (i.e., closest to ground plane 104) has the narrowestwidth604d. As a result, the forward gain of antenna element 102 is decreased, resulting in a more omni-directional radiation pattern of antenna element 102. In another embodiment, one or more of metal rings 602a-d may have the same width 604. For example, one or more pair of consecutive rings of metal rings 602a-d may have the same width 604.

Each of widths 604a-d may or may not be uniform along the sides. For example, a metal ring may have different side widths. Different side widths may be used to transform the antenna radiation into a “fan-shape,” which is more compressed along one of the two directions (x-direction or y-direction). In addition, the different sides of a ring may or may not have the same distance to antenna element 102.

Generally, the performance of the defocusing structure is determined, primarily, by widths 604a-d of metal rings 602a-d. Specifically, the respective values of widths 604a-d determine the amount of defocusing provided by the focusing structure. Other factors may also affect the performance of the defocusing structure, including, for example, the distance among rings 602a-d along the vertical direction, the geometrical shape of rings 602a-d (rectangular, circular, elliptical, etc.), the electrical properties of dielectric layers that separate rings 602a-d, and the presence or absence of vias connecting consecutive rings or connecting rings to ground plane 104 (e.g., connecting the bottom ring 602d to ground plane 104).

According to embodiments, metal rings 602a-d may have any geometrical shape, including a square shape, as shown in FIG. 6. As such, embodiments can accommodate various form factor requirements.

In other embodiment, metal rings 602a-d of the defocusing structure can be replaced with metal elements as described above in FIG. 4 or in FIG. 5. Specifically, one or more of metal rings 602a-d can be implemented as including a plurality of concentric metal rings, which may be electrically coupled to each other using active switches, for example. As such, the defocusing structure can be controlled dynamically to adjust its defocusing performance as desired.

As would be understood by a person of skill in the art based on the teachings herein, embodiments are not limited to use with single element antennas as described above in example systems 100, 400, and 600. For example, embodiments can be readily applied to multi-element antennas and/or antenna arrays. For example, a focusing/defocusing structure as described above may be formed around a multi-element antenna or an antenna array to shape the radiation pattern of the structure as desired.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

What is claimed is:

1. A system, comprising:
a ground plane;
an antenna element mounted in a plane above the ground plane; and
a radiation shaping structure, including a plurality of metal elements, each set in a respective plane parallel to the ground plane, the plurality of metal elements thrilling a multi-layer structure, peripheral to the antenna element.

2. The system of claim 1, wherein the antenna element includes one of a printed antenna and a patch antenna.

3. The system of claim 1, wherein the antenna element includes one or more of a single element antenna and a multi-element antenna array.

4. The system of claim 1, wherein the plurality of metal elements include a plurality of metal rings having respective widths.

5. The system of claim 4, wherein the respective widths of the plurality of metal rings progressively increase, in the direction away from the plane of the antenna element towards the ground plane.

6. The system of claim 5, wherein the radiation shaping structure is configured to increase a forward gain of the antenna element.

7. The system of claim 4, wherein the respective widths of the plurality of metal rings progressively decrease, in the direction away from the plane of the antenna element towards the ground plane.

8. The system of claim 7, wherein the radiation shaping structure is configured to reduce a forward gain of the antenna element.

9. The system of claim 4, wherein at least two of the respective widths of the plurality of metal rings are equal.

10. The system of claim 1, wherein at least one of the plurality of metal elements includes first and second concentric metal rings having first and second respective widths, the first and second concentric metal rings separated by a gap area.

11. The system of claim 10, further comprising:
a plurality of switches, controlled by respective control signals, located in the gap area between the first and second concentric metal rings.

12. The system of claim 11, wherein the plurality of switches are controlled by the respective control signals to electrically couple the first and second concentric metal rings to form a third metal ring, the third metal ring having an effective width equal to a sum of the first and second widths.

13. The system of claim 1, wherein at least one of the plurality of metal elements has an adjustable effective width.

14. The system of claim 13, wherein the radiation shaping provided by the radiation shaping structure is adjusted dynamically by adjusting the effective width of said at least one metal element.

15. The system of claim 1, wherein at least one of the plurality of metal elements includes a plurality of switches controllable to configure said at least one metal element to have a fully connected, partially connected, or disconnected metallization.

16. A integrated circuit (IC) package, comprising:
an integrated circuit (IC) chip; and
an antenna system, comprising:
a ground plane;
an antenna element mounted in a plane above the ground plane; and
a radiation shaping structure, including a plurality of metal elements, each set in a respective plane parallel to the ground plane, the plurality of metal elements forming a multi-layer structure, peripheral to the antenna element.

17. The IC package of claim 16, wherein the antenna element is mounted on the IC chip.

18. The IC package of claim 17, wherein the radiation shaping structure is integrated within the IC chip.

19. The IC package of claim 17, wherein the radiation shaping structure is built into the IC package.

20. A system, comprising:
an antenna element; and
a radiation shaping structure, including a plurality of metal elements, each set in a respective plane parallel to the antenna element, the plurality of metal elements forming a multi-layer structure, peripheral to the antenna element.
